(19) United States
(12) Patent Application Publication
(10) Pub. No.: US 2019/0198926 A1
(43) Pub. Date: Jun. 27, 2019

(54) ELECTROLYTE FOR NON-AQUEOUS ELECTROLYTE SECONDARY BATTERY

(71) Applicant: KURITA WATER INDUSTRIES LTD., Tokyo (JP)

(72) Inventors: Jun KANEKO, Tokyo (JP); Mitsuru NOZUE, Tokyo (JP)

(21) Appl. No.: 16/322,199

(22) PCT Filed: Sep. 2, 2016
(86) PCT No.: PCT/JP2016/075759

§ 371 Date: Jan. 31, 2019

(30) Foreign Application Priority Data
Aug. 3, 2016 (JP) 2016-153080

(51) Int. Cl. H01M 10/0567; H01M 10/0585; H01M 10/0525

(52) U.S. Cl. CPC H01M 10/0567; H01M 2300/0025; H01M 10/0525; H01M 10/0585

(57) ABSTRACT

As an electrolyte for a lithium ion battery, there is used one in which an inorganic adsorbent is dispersed in a non-aqueous electrolyte. The non-aqueous electrolyte is one having lithium ion conductivity, preferably a mixed solution of a cyclic carbonate such as propylene carbonate (PC) and ethylene carbonate (EC), and a chain carbonate such as dimethyl carbonate (DMC), ethyl methyl carbonate (EMC), diethyl carbonate (DEC) and the like. This solution may optionally be a solution in which a lithium salt, such as lithium hexafluorophosphate or the like, is dissolved as an electrolyte. The inorganic adsorbent to be dispersed in the non-aqueous electrolyte is preferably a Ca-exchanged A-type zeolite or an activated carbon. Such an electrolyte for a lithium ion battery is suitably used for a non-aqueous electrolyte secondary battery such as a lithium ion battery and is capable of highly maintaining the capability of absorbing moisture and gases.

### TECHNICAL FIELD

The present invention relates to an electrolyte to be used for a non-aqueous electrolyte secondary battery such as a lithium ion battery, and particularly to an electrolyte, to be used for a non-aqueous electrolyte secondary battery, having a capability of absorbing moisture and gases in the non-aqueous electrolyte secondary battery.

### BACKGROUND ART

In non-aqueous electrolyte secondary batteries such as lithium ion batteries, the internal temperature rises in case of abnormal incidents such as overcharging and short-circuiting and the internal pressure rises due to gases generated by evaporation or decomposition of their electrolyte along therewith, and thus the non-aqueous electrolyte secondary batteries suffer from such risks as breakage of their battery cases. Hence, a gas absorber is sealed in the non-aqueous electrolyte secondary batteries.

In this case, since the contact area of the gas absorber with the gases and the reaction speed must be increased, the gas absorber has been added and mixed with past-like conductive materials for a positive electrode and a negative electrode, and applied on the electrode surfaces, or the gas absorber has been kneaded with the electrode materials themselves. However, when a paste of the gas absorber is kneaded therein, the gas absorber is made into a fine powder of 10 μm or less, and there arise such problematic points that the dispersing effect of the fine powder vanishes in the ion-exchange reaction of the gas absorber and resultantly aggregation in a drying process produces lumps, making it unable for the particle size of the fine powder to be maintained, and generating unevenness on the electrodes or making the electrodes heterogeneous.

Further, the gas absorber to be used needs to be one having excellent gas absorption properties in the air; hence, the gas absorber ends in quickly absorbing moisture in the atmosphere of, for example, 5% by weight in a short time of about 5 min. and about 20% by weight in 150 min., thereby reducing the gas absorption capability. Therefore, when the gas absorber is kneaded in the electrodes or applied as a past-like one with a conductive material on the electrode surfaces, there arises such a problem in that the gas absorber absorbs moisture during the work, ending in reducing the gas absorption capability.

Then, the gas absorber, after crushed into a fine powder, is molded into a pellet form together with a binder and installed in a battery in some cases; however, there are such risks that the skeletal structure of the gas absorber is broken during the crushing, resulting in a decrease in the gas absorption capability, or that the binder dissolves in an electrolytic chamber to impose an adverse influence.

Then, various proposals have been made on simple means to suppress the reduction in the absorption capability of a gas absorber by incorporating the gas absorber in a liquid electrolyte (Patent Documents 1 to 4).

### PRIOR ART DOCUMENT

### Patent Document

[Patent Document 1] JPH5-315006A

[Patent Document 2] JPH7-262999A

[Patent Document 3] JPH9-139232A

[Patent Document 4] JPH11-260416A

### SUMMARY OF THE INVENTION

### Problems to be Solved by the Invention

If only mixing a gas absorber in an electrolyte as described in Patent Documents 1 to 4 enables the gas absorber to maintain the gas absorption properties, the work suffices with a simple work, but it was found that due to the excellent absorption properties of the gas absorber, the electrolyte mixed with the gas absorber absorbs moisture in a production process of a non-aqueous electrolyte secondary battery such as a lithium ion battery, whereby the absorption capability ends in decreasing.

The present invention has been achieved in consideration of the above problems, and has an object to provide an electrolyte that is suitably used for a non-aqueous electrolyte secondary battery such as a lithium ion battery and is capable of highly maintaining the capability of absorbing moisture and gases.

### Means for Solving the Problems

In order to achieve the above object, the present invention provides an electrolyte for a non-aqueous electrolyte secondary battery comprising a laminated body sealed in an airtight container, the laminated body comprising a positive electrode, a negative electrode, and a separator and being impregnated with a non-aqueous electrolyte, and lithium ions in the non-aqueous electrolyte being responsible for electrical conduction, wherein the non-aqueous electrolyte is a non-aqueous electrolyte comprising an inorganic adsorbent having a moisture content adjusted to 2% by weight or less and being dispersed in a liquid non-aqueous electrolyte (Invention 1).

According to the above invention (Invention 1), since the inorganic adsorbent having a moisture content adjusted to 2% by weight or less is dispersed in the liquid non-aqueous electrolyte, direct contact of the inorganic adsorbent with a gas phase is avoided so that it becomes difficult for the inorganic adsorbent to absorb moisture in the atmosphere. By injecting the liquid non-aqueous electrolyte having the inorganic adsorbent dispersed therein during a production process of a non-aqueous electrolyte secondary battery, the inorganic adsorbent can absorb moisture and gas components generated in an obtained non-aqueous electrolyte secondary battery.

In the above invention (Invention 1), it is preferable that the inorganic adsorbent have a moisture removal capability (Invention 2).

According to the above invention (Invention 2), since the inorganic adsorbent absorbs moisture present inside the battery, the inorganic adsorbent can remove not only humidity and gas components but also moisture in an electrolyte, which enables reduction in battery performance to be suppressed.

In the above inventions (Inventions 1 and 2), it is preferable that the inorganic adsorbent be an A-type, X-type or Y-type zeolite (Invention 3).

According to the above invention (Invention 3), the inorganic adsorbent can absorb gas components and moisture quickly and at a high absorption rate.

In the above inventions (Inventions 1 and 2), it is preferable that the inorganic adsorbent be a carbon-based adsorbent (Invention 4).

According to the above invention (Invention 4), the inorganic adsorbent can absorb gas components and moisture quickly and at a high absorption rate.

In the above inventions (Inventions 1 to 4), it is preferable that the inorganic adsorbent have a particle size of 10 μm or less (Invention 5).

According to the above invention (Invention 5), the inorganic adsorbent is well dispersed in a liquid non-aqueous electrolyte and does not impair fluidity of the electrolyte.

In the above inventions (Inventions 1 to 5), it is preferable that the inorganic adsorbent have a pore size of 3 Å to 10 Å (Invention 6).

According to the above invention (Invention 6), the inorganic adsorbent captures gas components and moisture in its pores, and can thereby quickly absorb these.

In the above inventions (Inventions 1 to 6), it is preferable that a moisture content of the non-aqueous electrolyte can be held at 10% by weight or less (Invention 7).

According to the above invention (Invention 7), the amount of moisture taken in can be controlled at an amount which does not incur reduction in the performance of the non-aqueous electrolyte secondary battery.

In the above inventions (Inventions 1 to 7), it is preferable that after the inorganic adsorbent has been dispersed in the liquid non-aqueous electrolyte, the electrolyte be stored in a hermetically sealed state (Invention 8).

According to the above invention (Invention 8), by injecting the electrolyte during the production process of a non-aqueous electrolyte secondary battery while the inorganic adsorbent maintains the capability of absorbing gas components and moisture without absorbing humidity and the like in the air, the capability of absorbing moisture and gas components generated in the obtained non-aqueous electrolyte secondary battery can be held high.

### Effect of the Invention

According to the present invention, since an inorganic adsorbent having a moisture content adjusted to 2% by weight or less is dispersed in a liquid non-aqueous electrolyte, direct contact of the inorganic adsorbent with a gas phase is avoided so that it becomes difficult for the inorganic adsorbent to absorb moisture in the atmosphere; hence, by injecting the liquid non-aqueous electrolyte having the inorganic adsorbent dispersed therein during a production process of a non-aqueous electrolyte secondary battery, the inorganic adsorbent can absorb moisture and gas components generated in an obtained non-aqueous electrolyte secondary battery.

### BRIEF DESCRIPTION OF DRAWINGS

FIG. 1 is a flowchart showing a production process of a lithium ion battery according to one embodiment of the present invention.

FIG. 2 is a graph showing a relation between the moisture content and the amount of carbon dioxide adsorbed of an inorganic adsorbent used for an electrolyte for a non-aqueous electrolyte secondary battery of Example 1.

FIG. 3 is a graph showing a relation between the amount of carbon dioxide adsorbed and the absorption time of an electrolyte for a non-aqueous electrolyte secondary battery of Example 2.

### EMBODIMENTS FOR CARRYING OUT THE INVENTION

Hereinafter, embodiments of the present invention will be described in detail. However, the embodiments are just exemplifications, and the present invention is not any more limited thereto.

In the present embodiment, a lithium ion battery as a non-aqueous electrolyte secondary battery is, for example, one in which a positive electrode body and a negative electrode body are sealed together with an electrolyte in an airtight container, wherein lithium ions in the electrolyte are responsible for electrical conduction; and the lithium ion battery has a structure in which a laminated body including electrode sheets and a separator is formed into a roll shape and lead portions of the positive electrode body and the negative electrode body as current collectors are connected to corresponding terminals. After the roll-shape laminated body has been accommodated in the cylindrical airtight container, the electrolyte is injected through an opening of the airtight container to impregnate the laminated body with the electrolyte; and the battery container is sealed in such a state that heads of the positive electrode body and the negative electrode body are exposed outside.

In the present embodiment, as the electrolyte of the lithium ion battery described above, an electrolyte in which an inorganic adsorbent is dispersed in a non-aqueous electrolyte is used. The non-aqueous electrolyte is one having lithium ion conductivity, preferably a mixed solution of a cyclic carbonate such as propylene carbonate (PC) and ethylene carbonate (EC), and a chain carbonate such as dimethyl carbonate (DMC), ethyl methyl carbonate (EMC), diethyl carbonate (DEC) and the like. This solution may optionally be a solution in which a lithium salt, such as lithium hexafluorophosphate or the like, is dissolved as an electrolyte. There can be used, for example, a mixed solution prepared by mixing ethylene carbonate (EC), ethyl methyl carbonate (EMC) and dimethyl carbonate (DMC) in a ratio of 1:1:1, or a mixed solution prepared by mixing propylene carbonate (PC), ethylene carbonate (EC) and diethyl carbonate (DEC) in a ratio of 1:1:1, to which 1 mol/L of lithium hexafluorophosphate has been added.

Further, the inorganic adsorbent to be dispersed in the non-aqueous electrolyte suffices as long as having a function of adsorbing CO, CO₂ or other gas components and moisture (water and humidity) generated by decomposition of the electrolyte, and hydrofluoric acid and the like generated by a reaction between a lithium salt and moisture. The inorganic adsorbent specifically includes inorganic porous materials and carbon-based materials. Here, the other gas components include ethylene gas, oxygen, nitrogen, and methane gas a; and these gas components can also be adsorbed by suitably selecting the pore size of the inorganic adsorbent.

As the inorganic porous material, suitable are porous silica, a metal porous structure, calcium silicate, magnesium silicate, magnesium aluminometasilicate, zeolite, activated alumina, titanium oxide, apatite, porous glass, magnesium oxide, aluminum silicate and the like.

As the carbon-based material, suitable are activated carbon such as fine-powdered activated carbon, granular activated carbon, fibrous activated carbon and sheet-like activated carbon, graphite, carbon nanotubes, fullerene, nanocarbon and the like.

These inorganic adsorbents may be used alone, or two or more materials be used in combination, but zeolite is especially effectively used.

It is preferable that the inorganic adsorbent as described above have a specific surface area of 100 to 3,000 m²/g. When the specific surface area is smaller than 100 m²/g, the contact area with gas components such as CO₂ and moisture is small, and a sufficient adsorption performance cannot be exhibited. On the other hand, when the specific surface area exceeds 3,000 m²/g, not only the effect of improving adsorption performance for gas components such as CO₂ and moisture cannot be attained, but also the mechanical strength of the inorganic adsorbent deteriorates; therefore, the case is not preferable.

Further, it is preferable that the inorganic adsorbent have a pore size of 3 Å or more and 10 Å or less. When the pore size volume is less than 3 Å, entry of gas components such as CO₂ and moisture into the pores becomes difficult. On the other hand, in the case where the pore size volume exceeds 10 Å, the adsorptive power for gas components such as CO₂ and moisture ends in weakening, whereby the gas components and moisture cannot be adsorbed in the densest manner in the pores, and the adsorption amount resultantly decreases; therefore, the case is not preferable.

Further, when the inorganic adsorbent is zeolite, it is preferable to use a zeolite having a Si/Al elemental composition ratio in the range of 1 to 5. A zeolite having a Si/Al ratio of less than 1 has an unstable structure; on the other hand, a zeolite having a Si/Al ratio of more than 5 has a low cation content and reduces the amounts of gas components such as CO₂ absorbed and moisture; hence, these zeolites are not preferable.

Here, as the zeolite, it is preferable to use an A-type, Y-type or X-type zeolite. In particular, an A-type zeolite, in which the cation part of the zeolite has been ion-exchanged with Ca, is preferable.

Such an inorganic adsorbent absorbs humidity in the atmosphere in some cases. Then, the inorganic adsorbent, when having absorbed humidity (moisture), reduces largely the capability of absorbing moisture and gas components such as CO₂. In various types of zeolites, particularly in the A-type zeolite that has been ion-exchanged with Ca, however, the absorption capability can easily be reproduced by purging moisture by heating.

In the present embodiment, it is preferable that the inorganic adsorbent as described above be made into a fine powder having an average particle size of 10 μm or less. With the particle size exceeding 10 μm, the dispersibility to the non-aqueous electrolyte worsens and the impregnability of an obtained electrolyte reduces. Here, the lower limit of the average particle size being smaller than 0.5 μm not only reduces the handleability but also reduces the gas absorption capability; therefore, it is preferable that the average particle size be made to be 0.5 μm or more.

The mixing proportion of such a non-aqueous electrolyte and such an inorganic adsorbent may be such that 0.1 to 5 parts by weight, especially 1 to 3 parts by weight, of an inorganic adsorbent is blended with respect to 100 parts by weight of a non-aqueous electrolyte. With the amount of the inorganic adsorbent blended being lower than 0.1 parts by weight, the capability of absorbing moisture and gas components such as CO₂ in an obtained electrolyte is not sufficient; on the other hand, with the amount blended exceeding 5 parts by weight, not only the effect of improving the absorption capability corresponding thereto cannot be attained but also the fluidity and the impregnability of the obtained electrolyte reduce and the handleability worsens; therefore, these cases are not preferable.

At this time, the inorganic adsorbent needs to be one having a moisture content adjusted to 2% by weight or less, that is, a moisture amount adjusted to 2 parts by weight or less with respect to 100 parts by weight of the inorganic adsorbent. When an inorganic adsorbent having a moisture content of exceeding 2% by weight is blended, the capability of absorbing moisture and gas components such as CO₂ becomes unable to be sufficiently exhibited. Further, it is preferable to use a non-aqueous electrolyte having previously been subjected to a dehydration treatment.

The electrolyte of the present embodiment thus obtained, when being left in the air, absorbs moisture in the air and ends in reducing the performance. Therefore, it is preferable that after the inorganic adsorbent has been dispersed in a liquid non-aqueous electrolyte, the electrolyte be stored in a hermetically sealed state by placing it in a hermetically sealable container, or otherwise. Thereby, by injecting the electrolyte during a production process of a lithium ion battery while inorganic adsorbent maintains the capability of absorbing gas components and moisture without absorbing humidity and the like in the air, the capability of absorbing moisture and gas components generated in the lithium ion battery can be held high.

Further, using the electrolyte of the present embodiment enables the effect of dehydrating moisture in the non-aqueous electrolyte to be exhibited and the moisture content in the non-aqueous electrolyte to be held at 10% by weight or less, and the amount of moisture taken in can therefore be controlled at an amount which does not incur reduction in the performance of the lithium ion battery.

Now, a production process of a lithium ion battery using the electrolyte of the present embodiment will be described.

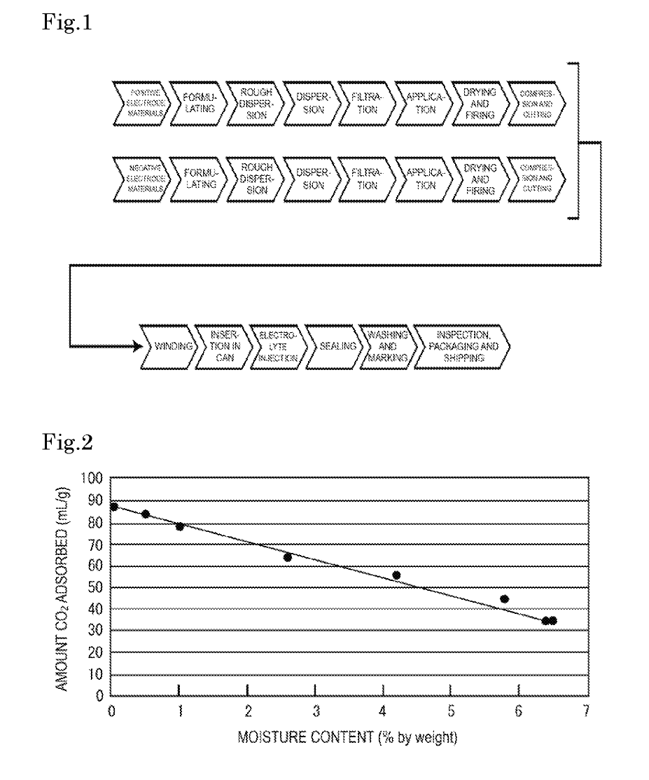

A lithium ion battery to be produced in the present embodiment is cylindrical, in which a laminated body including electrode sheets and a separator is formed into a roll shape, and is produced through a flow indicated in FIG. 1. That is, positive electrode materials and negative electrode materials are each formulated; thereafter, the formulated materials are each mixed with a binder and/or a solvent and roughly dispersed, then dispersed; and the resultants are filtered to make past-like electrode materials. Meanwhile, an aluminum foil is used for a positive electrode and a copper foil is used for a negative electrode; and these past-like electrode materials are applied and dried on the aluminum foil being the positive electrode and the copper foil being the negative electrode, respectively, and thereafter fired. Then, the fired bodies are compressed so as to have uniform thicknesses, and then cut after the shape and the size of the battery to thereby make a positive electrode sheet and a negative electrode sheet. Thereafter, a separator being an insulating film is interposed between the positive electrode and the negative electrode, and wound up cylindrically like a baumkuchen so that the positive electrode, the negative electrode and the separator make multiple layers (winding). The wound-up battery main body is inserted in a cylindrical can body; and the electrode butting at the can bottom is welded. Then, the electrolyte of the present embodiment having been hermetically sealed just before is unsealed and immediately injected; and the electrode butting at a lid is welded, and sealed; a lithium ion battery can thus be produced. Then, washing and marking such as product display being post-processes are carried out; and the resultant is inspected and packaged and thereafter shipped out to thereby complete the production process. Since the electrolyte of the present embodiment is stored in a hermetically sealed state, and unsealed right before the injection to the can body and then injected as described above, the lithium ion battery can be produced while absorption of moisture and the like in the air by the electrolyte is evaded to the utmost.

Hitherto, the present invention has been described by reference to the accompanying drawings, but the present invention is not limited to the above embodiments, and various changes and modifications may be made. For example, the lithium ion battery as a non-aqueous electrolyte secondary battery can be applied to a rectangular battery bath can, not limited to a cylindrical one.

### EXAMPLES

The present invention will be described in more detail based on the following specific Examples, but the present invention is not limited to the following Examples.

### Test of Influence of Moisture Content of Inorganic Adsorbents

### Example 1

A Ca-exchanged A-type zeolite having an average particle size of 5 μm as an inorganic adsorbent was prepared, and sufficiently dried, and thereafter immersed in water. The inorganic adsorbent was taken out from the water, and made to vaporize moisture in various drying times; the inorganic adsorbents thus dried were left for a predetermined time in a CO₂-containing gas, and then made to release the occluded CO₂ and moisture under reduced pressure by using a gas analyzer (“BELSORP-max”, manufactured by MicrotracBEL Corp.); and the amount of CO₂ adsorbed and the moisture amount were measured and the amount of CO₂ adsorbed per unit weight of the inorganic adsorbent and the moisture content (moisture amount (parts by weight) with respect to 100 parts by weight of the inorganic adsorbent) (%) were calculated. The results are shown in FIG. 2.

As is clear from FIG. 2, the Ca-exchanged A-type zeolite being an inorganic adsorbent had an amount of CO₂ adsorbed of a maximum (at a moisture content of 0%) of about 90 mL/g, whereas with the moisture content of about 6.5% by weight, which is the usual moisture content when having been left in the air, the amount of CO₂ adsorbed was about 35 mL/g. Further, it was found that in the case of the moisture content of 2% by weight or less, which is specified in the present invention, the amount of CO₂ adsorbed was about 70 mL/g, attaining the absorbing effect about twice that in the case of 6.5% by weight. Therefore, it can be presumed that by immersing an inorganic adsorbent in a dried state in a non-aqueous electrolyte whose moisture has been reduced, the maximum adsorption amount can be exhibited and the removal of moisture generated in a lithium ion battery can be sustained at the maximum.

### Test for Confirming CO₂ Absorbing Speed and CO₂ Adsorption Capability

### Example 2

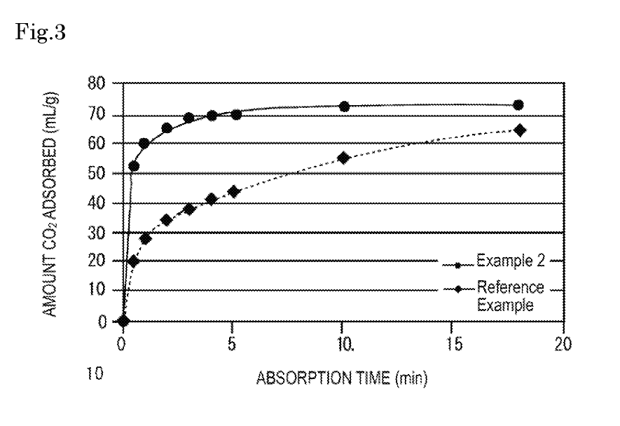

A Ca-exchanged A-type zeolite having an average particle size of 5 μm as an inorganic adsorbent was prepared, and dried to adjust the moisture content to 1 to 2%. 1 g of the inorganic adsorbent was dispersed in 50 mL of a fully dehydrated non-aqueous electrolyte (1 mmol/L of LiPF₆ had been dissolved in a mixed solution of ethylene carbonate (EC):ethyl methyl carbonate (EMC)=3:7) to thereby make an electrolyte of Example 2. The electrolyte was left in a CO₂-containing gas for predetermined times and thereafter taken out; and the occluded CO₂ was made to be released under reduced pressure by using the same gas analyzer as in Example 1, and the occlusion amount was measured and the amount of the CO₂ gas adsorbed per unit weight was measured. The results are shown in FIG. 3. For comparison, there is also shown in FIG. 3 the result of the similar measurement of the amount of CO₂ gas adsorbed by a Ca-exchanged A-type zeolite alone, which has a moisture content adjusted to 1 to 2% (Reference Example).

As is clear from FIG. 3, it was found that the electrolyte of Example 2, in which an inorganic adsorbent was dispersed in a non-aqueous electrolyte, though having a lower gas absorbing speed, had a decrease in the absorption capability by only about 10%, giving a sufficient gas absorption capability.

### Test for Confirming Moisture Absorption Capability

### Example 3

A Ca-exchanged A-type zeolite having an average particle size of 5 μm as an inorganic adsorbent was prepared, and dried to adjust the moisture content to 1 to 2%. 1 g of the inorganic adsorbent was dispersed in 50 mL of a fully dehydrated non-aqueous electrolyte (1 mmol/L of LiPF₆ had been dissolved in a mixed solution of ethylene carbonate (EC):ethyl methyl carbonate (EMC)=3:7) to thereby prepare an electrolyte of Example 3. 0.25 mL of pure water was dropped in the electrolyte, and left for a predetermined time and thereafter taken out; and the occluded moisture was made to be released under reduced pressure by using a gas analyzer (“GC-4000”, manufactured by GL Sciences Inc.), and the occlusion amount was measured; and moisture of 0.23 mL/g per unit weight of the inorganic adsorbent was adsorbed, whereby it was confirmed that the electrolyte of Example 3 had a sufficient moisture adsorption capability.

1. An electrolyte for a non-aqueous electrolyte secondary battery comprising a laminated body sealed in an airtight container, the laminated body comprising a positive electrode, a negative electrode, and a separator and being impregnated with a non-aqueous electrolyte, and lithium ions in the non-aqueous electrolyte being responsible for electrical conduction,
wherein the non-aqueous electrolyte is a non-aqueous electrolyte comprising an inorganic adsorbent having a moisture content adjusted to 2% by weight or less and being dispersed in a liquid non-aqueous electrolyte.

2. The electrolyte for a non-aqueous electrolyte secondary battery as recited in claim 1, wherein the inorganic adsorbent has a moisture removal capability.

3. The electrolyte for a non-aqueous electrolyte secondary battery as recited in claim 1, wherein the inorganic adsorbent is an A-type, X-type or Y-type zeolite.

4. The electrolyte for a non-aqueous electrolyte secondary battery as recited in claim 1, wherein the inorganic adsorbent is a carbon-based adsorbent.

5. The electrolyte for a non-aqueous electrolyte secondary battery as recited in claim 1, wherein the inorganic adsorbent has a particle size of 10 μm or less.

6. The electrolyte for a non-aqueous electrolyte secondary battery as recited in claim 1, wherein the inorganic adsorbent has a pore size of 3 Å to 10 Å.

7. The electrolyte for a non-aqueous electrolyte secondary battery as recited in claim 1, wherein a moisture content of the non-aqueous electrolyte can be held at 10% by weight or less.

8. The electrolyte for a non-aqueous electrolyte secondary battery as recited in claim 1, wherein after the inorganic adsorbent has been dispersed in the liquid non-aqueous electrolyte, the electrolyte is stored in a hermetically sealed state.
